(19) United States
(12) Patent Application Publication
(10) Pub. No.: US 2004/0067778 A1
(43) Pub. Date: Apr. 8, 2004

(54) Mobile terminal

(76) Inventors: Norifumi Sata, Hyogo (JP); Masakazu Nakamura, Osaka (JP)

Correspondence Address: RATNERPRESTIA, P O BOX 980, VALLEY FORGE, PA, 19482-0980, US

(21) Appl. No.: 10/610,965

(22) Filed: Jul. 1, 2003

(30) Foreign Application Priority Data
Jul. 26, 2002 (JP) 2002-217860

(51) Int. Cl. H04M 1/00

(52) U.S. Cl. 455/566

(57) ABSTRACT

A mobile terminal which has a tag section and menu section in a display. The tag section displays tags indicating menu names. A controller displays contents of one of tags on the menu section when the tag is selected by operating left and right selection keys. This allows to immediately switch to other menu just by selecting a tag shown on the display. Accordingly, an easy-to-use mobile terminal which requires fewer operations is achieved.

### BACKGROUND OF THE INVENTION

1. Field of the Invention

The present invention relates to mobile terminals used typically as remote controls for operating apparatuses remotely and personal digital assistants (PDAs).

2. Background Art

Remote controls for operating apparatuses remotely and PDAs have been increasingly used in recent years, and thus mobile terminals with better operability are demanded for remote operations.

A conventional mobile terminal is described next with reference to FIGS. 7, 8 and 9A to 9C.

FIG. 7 is an external view of the conventional mobile terminal, and FIG. 8 is a block circuit diagram of the conventional mobile terminal. In FIG. 7, display 1 such as a liquid crystal display is disposed at the left front of the mobile terminal.

At the right front, up and down keys 2D and 2E; right and left keys 2F and 2G; entry key 2C, power key 2A, and so on are disposed to compose input unit 2.

Controller 3, configured typically with a microcomputer, is provided inside, and transmitter 4 is disposed at the upper part of display 1. This transmitter 4 converts electrical signals from controller 3 to infrared optical signals for transmission. Transmitter 4, input unit 2, and display 1 are connected to controller 3 to configure the mobile terminal.

In the above structure, the case of using this mobile terminal as a remote control such as for selecting channels or turning ON/OFF the power of a TV or VCR is described next.

First, when power key 2A is pressed, controller 3 detects it, and an initial screen showing names of apparatuses such as “TV,” “VCR,” and “STB” as functional items is displayed, as shown in the display screen in FIG. 9A.

A semi-transparent cursor 1A for selecting displayed items is placed on “TV” at the top.

For example, to set the TV channel to 2, entry key 2C is pressed without any change because cursor 1A is already placed on “TV.” Controller 3 then detects this operation and a menu screen showing the subsequent operable functional items such as “ON” and “OFF” which means to turn ON/OFF the TV power, and “1,” “2” and so on which means the TV channel number, as shown in FIG. 9B, are displayed on display 1.

In this screen, semi-transparent cursor 1A for selecting displayed items is placed at “ON” at the left top.

Since channel “2” which needs to be selected is located at the lower right of “ON” where cursor 1A is placed, down key 2E is pressed once. Controller 3 detects it and moves cursor 1A to “1.” Then, right key 2G is pressed once to move cursor 1A to “2” in the same way.

Entry key 2C is finally pressed. Controller 3 detects it and outputs an electrical signal for remote control corresponding to “2.” Transmitter 4 converts this electrical signal to an infrared optical signal, and sends it to the TV such that the TV is remote controlled to set the TV channel to “2.”

The case of turning ON/OFF the power of a VCR by switching an apparatus to be remote controlled from TV to VCR is described next.

First, in the state shown in FIG. 9B while operable functional items for TV are displayed on display 1, HOME key 2B is pressed. Controller 3 detects this operation, and returns the display to the initial screen where the name of each apparatus is shown as in FIG. 9A.

In this state, since “VCR” which needs to be selected is found beneath “TV” where cursor 1A is placed, down key 2E is pressed once to move cursor 1A to “VCR.”

Next, entry key 2C is pressed once. Controller 3 then displays a menu screen showing subsequent operable functional items for “VCR” such as “ON” and “OFF” for turning ON/OFF the VCR power, “rec” for recording, and so on on display 1.

At this point, semi-transparent cursor 1A is placed at “ON” at the left top.

To turn on a VCR in this state, entry key 2C is pressed immediately so that controller 3 outputs a remote-control electrical signal corresponding to “ON.” Transmitter 4 sends an infrared optical signal to the VCR to turn it on.

Accordingly, to switch an apparatus to be remote controlled, the prior art is configured in a way such that HOME key 2B is pressed to return the display to the initial screen as shown in FIG. 9A. A target apparatus is then selected to display the menu screen for that target apparatus.

In the conventional mobile terminal, it is thus necessary to press HOME key 2B to first return to the initial screen where names of apparatuses are listed in order to switch the apparatus to be operated. This increases the number of operations, making operation cumbersome.

### SUMMARY OF THE INVENTION

The present invention offers a mobile terminal which includes a display having a menu section for displaying a predetermined function and a tag section for displaying the menu name; an input unit where selection keys and entry key are provided; and a controller connected to the input unit and display. Multiple tags are displayed on the tag section, and a required tag is selected by operating a selection key. The controller then displays the content of the selected tag on the menu section.

### BRIEF DESCRIPTION OF THE DRAWINGS

FIG. 1 is an external view of a mobile terminal in accordance with a first exemplary embodiment of the present invention.

FIG. 2 is a block circuit diagram in accordance with the first exemplary embodiment.

FIG. 3 is a display screen in accordance with the first exemplary embodiment.

FIG. 4 is an external view of a mobile terminal in accordance with a second exemplary embodiment of the present invention.

FIG. 5 is a block circuit diagram in accordance with the second exemplary embodiment of the present invention.

FIGS. 6A, 6B, 6C, and 6D are display screens in accordance with the second exemplary embodiment of the present invention.

FIG. 7 is an external view of a conventional mobile terminal.

FIG. 8 is a block circuit diagram of the prior art.

FIGS. 9A, 9B, and 9C are display screens of the prior art.

### DETAILED DESCRIPTION OF THE INVENTION

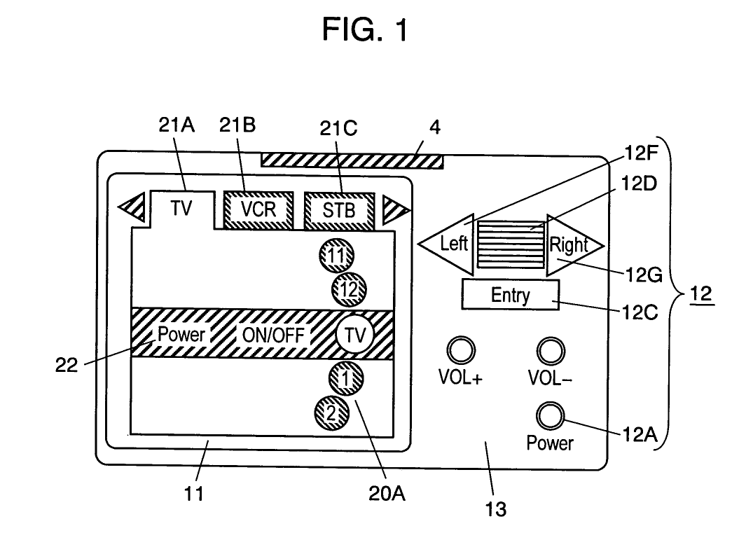

Exemplary embodiments of the present invention are described below with reference to FIGS. 1 to 6A, 6B, 6C, and 6D.

The same structure as that described in the prior art is given the same reference numerals to omit detailed description.

First Embodiment

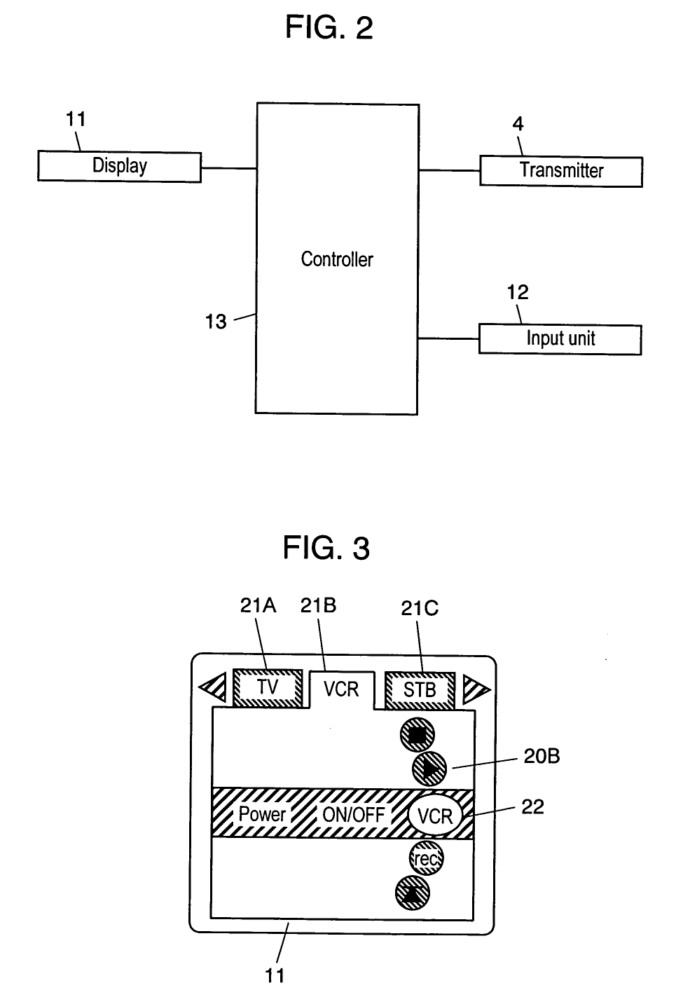

FIG. 1 is an external view of a mobile terminal in a first exemplary embodiment of the present invention, and FIG. 2 is a block circuit diagram. In FIG. 1, display 11 such as a liquid crystal display is provided on the left front of this mobile terminal.

This display 11 shows menu 20A in which functional items such as “Power ON/OFF TV” for turning ON/OFF the TV power, and “1,” “2,” and so on, which are TV channels, are aligned in an approximately circular arc.

At the upper part of this menu 20A, tag 21A for “TV” indicating the name of this menu 20A and other tags 21B and 21C such as “VCR” and “STB” are displayed.

At the right front of the mobile terminal, keys including left key 12F, right key 12G, entry key 12C, power key 12A are disposed. Switches for electrical connection and disconnection in response to pressing the keys are disposed respectively at the back of these keys.

A cylindrical up/down selection key 12D which rotates vertically is disposed between left key 12F and right key 12G. A rotary encoder, which operates by rotating selection key 12D, is connected at the back of selection key 12D. These keys configure input unit 12.

Controller 13, configured typically with a microcomputer, is disposed inside the mobile terminal. Transmitter 4, such as an infrared light-emitting diode which converts electrical signals from this controller 13 to infrared optical signals for transmission, is disposed at the upper part of display 11. The mobile terminal is configured by connecting this transmitter 4, input unit 12, and display 11 to controller 13.

In the above configuration, the case of using this mobile terminal as a remote control such as for selecting a channel or turning ON and OFF the power of TV or VCR through remote operations is described next.

First, when power key 12A is pressed, controller 13 detects it and displays TV menu 20A, tag 21A for this menu 20A and other tags 21B and 21C on display 11 as shown in FIG. 1.

In other words, unlike the prior art in which an initial screen indicating multiple apparatuses is first displayed and then the apparatus to be operated is selected by the entry key to display the menu for selected apparatus, selected menu 20A and its tag 21A and other tags 21B and 21C are simultaneously displayed just by operating power key 12A. Semi-transparent cursor 22 for selecting items to display is fixed at approximately the center of the screen, and a functional item selected by this cursor 22, which is “Power ON/OFF TV” in FIG. 1, is displayed larger than the other functional items such as “1,” “2” and so on.

The case of setting channel “2” for TV is described next as an example.

Since “2” is located beneath cursor 22 at the center, up/down selection key 12D is rotated upward. Controller 13 detects the movement of rotary encoder linked to this movement of selection key 12D, and moves each functional item displayed in menu 20A upward.

More specifically, an item “Power ON/OFF TV” moves upward out of cursor 22, and an item “1” comes to cursor 22. The item “1” then moves upward out of cursor 22 and an item “2” comes to cursor 22 by holding the finger on this selection key 12D and further rotating it upward.

When entry key 12C is pressed while “2” is selected by cursor 22 and shown in a larger size, controller 13 detects this operation and outputs an electrical signal for remote control corresponding to “2.” Transmitter 4 sends this electrical signal in the form of an infrared optical signal to the TV so that the TV is operated remotely to set the TV channel to “2.”

Next, the case of turning ON/OFF the power of VCR after switching an apparatus to be remote controlled from TV to VCR is described.

Tag 21B for “VCR” to be selected is located at the right of tag 21A for “TV” whose menu 20A is presently displayed. Accordingly, right key 12G is pressed once so that controller 13 detects it to select tag 21B.

Then, as shown on a display screen in FIG. 3, menu 20B indicating functional items for VCR including “Power ON/OFF VCR” which means to turn ON/OFF the power of VCR and “rec” which means recording by VCR is displayed on display 11.

Even if the menu displayed is switched from menu 20A to menu 20B, tag 21a for “TV” and tag 21C for “STB” are kept displayed.

Semi-transparent cursor 22 is fixed at approximately the center of the screen, and an item “Power ON/OFF VCR” is selected using this cursor 22.

To turn ON the power of VCR in this state, entry key 12C is pressed immediately. Controller 13 then outputs an electrical signal for remote control corresponding to this operation, and transmitter 4 sends an infrared optical signal to VCR to turn on the VCR.

In the first exemplary embodiment, multiple tags 21A, 21B, and 21C indicating the menu names are displayed on display 11, and controller 13 displays the contents of the menu selected by designating a tag using left key 12F and right key 12G. This makes it possible to immediately switch to another menu by simply selecting one of the tags displayed on display 11. Accordingly, the number of operations is reduced, offering a mobile terminal with better operability.

Moreover, approximately cylindrical up/down selection key 12D, which is vertically rotatable, is employed so that items in the menu are selectable by rotating this key 12D. This allows the finger to be kept on the up/down selection key 12D and rotated to select a functional item such as channel “2” displayed in the menu by vertically moving the items, allowing rapid operation without error.

Still more, multiple functional items in the menu are listed in an approximately arc which conforms to the shape of approximately cylindrical key 12D. This provides a feel of conformance between the operation of selection key 12D and movement of functional items displayed in the menu, achieving further better operability.

Still more, a selected functional item in the menu is displayed larger than the other functions so that the selected function is easy to notice, facilitating selection.

In this exemplary embodiment, entry key 12C is disposed beneath up/down selection key 12D. However, selection key 12D can be designed to vertically rotate and also be pushed, and a switch for electrical connection and disconnection by this pushing operation can be disposed at the back to integrate selection key 12D and entry key 12C. This makes it possible to select and enter the functional item using one selection key 12D, further improving operability.

Furthermore, selection key 12D can be designed in a globular shape to integrate left key 12F and right key 12G.

Still more, selection key 12D can be disposed at the right side face of the mobile terminal other than the right front of display 11.

This exemplary embodiment refers to three tags 21A, 21B, and 21C as an example. It is apparent that there is no limit to the number of tags. If the number of tags is too many to be displayed all at once, they can be scrolled horizontally by using left key 12F and right key 12G to display all the tags.

Second Embodiment

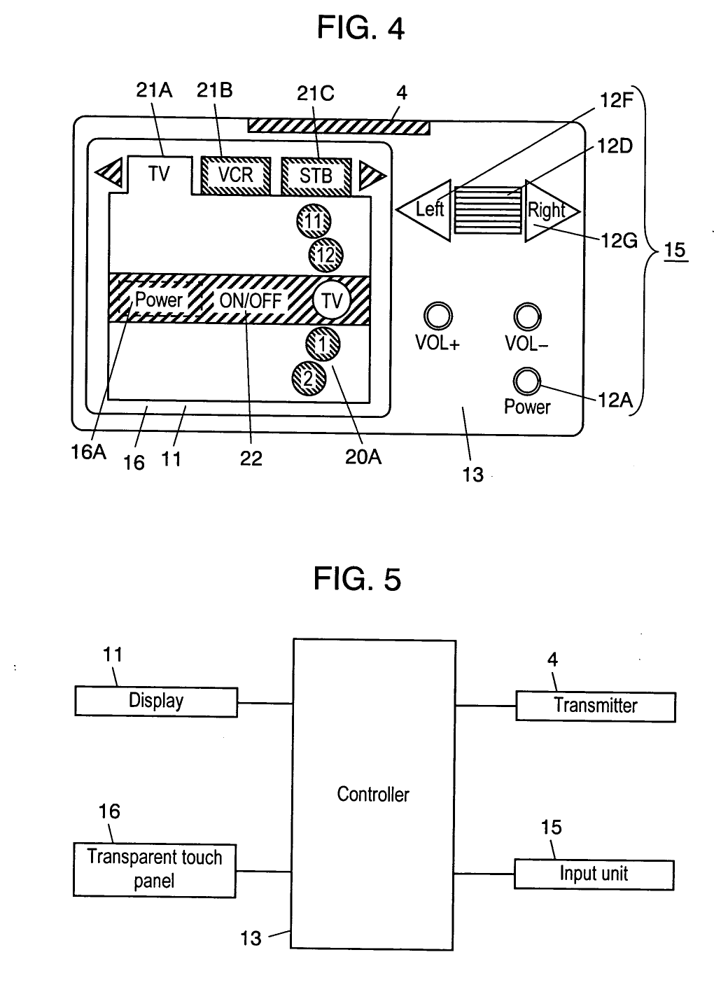

FIG. 4 is an external view of a mobile terminal in a second exemplary embodiment of the present invention, and FIG. 5 is a block circuit diagram. In FIG. 4, display 11 is disposed at the left front of the mobile terminal, which is the same as that in the first exemplary embodiment.

Also, in the same way, menu 20A showing functions for TV, tag 21A for this menu 20A, and other tags 21B and 21C are displayed in this display 11.

At the right front of the mobile terminal, keys including left key 12F, right key 12G, up/down selection key 12D, power key 12A are disposed, configuring input unit 15.

In the second exemplary embodiment, entry key is disposed on the front face of display 11, unlike the first exemplary embodiment which has the entry key disposed beneath up/down selection key 12D. The entry key is configured with a flexible top substrate where a transparent upper electrode such as of indium tin oxide is formed on its bottom face and a bottom substrate where a bottom electrode facing the top electrode is disposed on its top face with a predetermined gap with respect to the top electrode, i.e., so-called transparent touch panel 16.

Controller 13 is disposed inside the mobile terminal, and transmitter 4 is disposed at the upper part of display 11. The mobile terminal is configured by connecting this transmitter 4, input unit 15, display 11, and transparent touch panel 16 to controller 13.

The case of using the mobile terminal as configured above as a remote control is described next. Here, the remote control is used for selecting a channel from many channels such as in satellite broadcasts and cable TV, unlike selecting from about 12 channels which is the case in a TV using a conventional antenna. For example, the case of setting channel “213” for STB (satellite broadcast) is described.

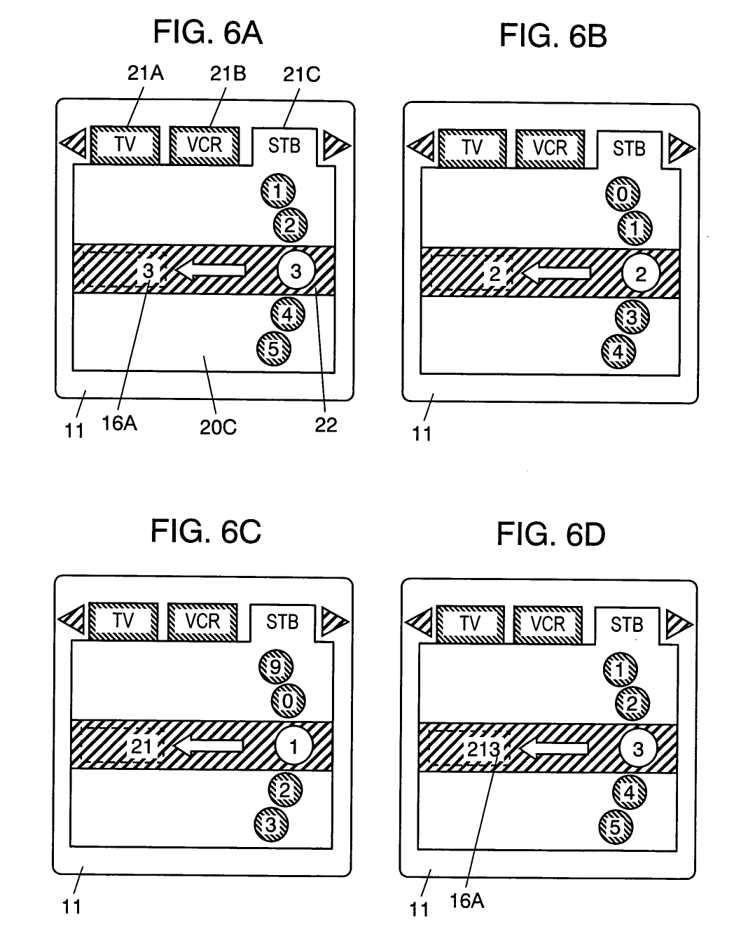

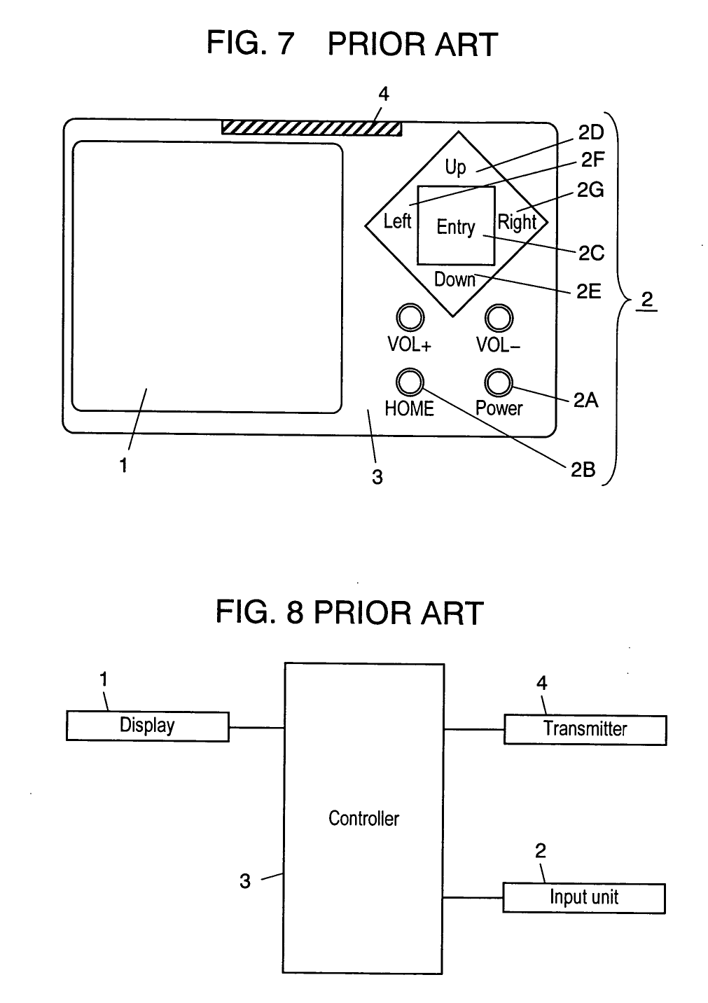

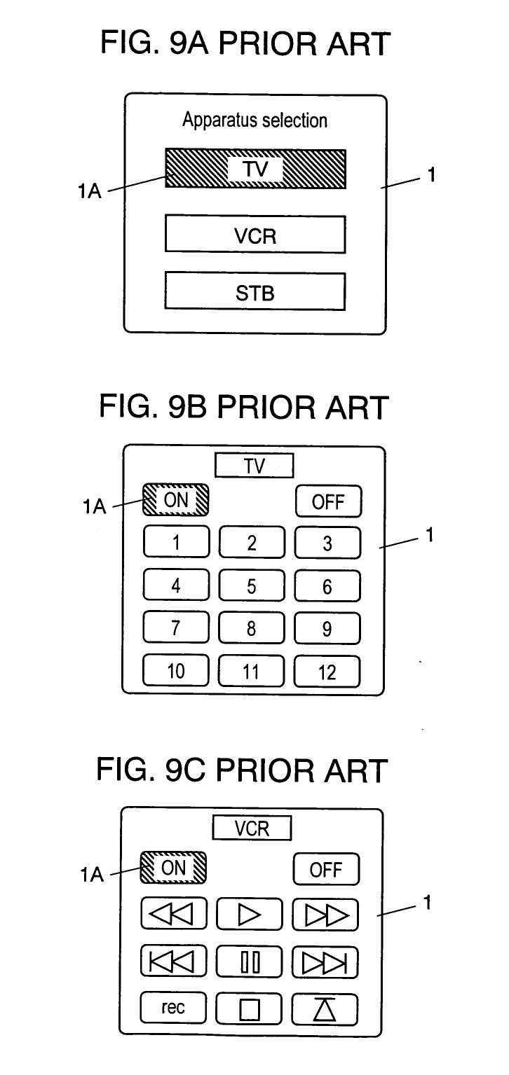

First, after pressing power key 12A, a tag is selected in the same way as the first exemplary embodiment to switch an apparatus to remote control from TV to STB. Controller 13 then detects it, and displays menu 20C showing channel selecting items for multiple channels such as “1” and “2” indicating channels for STB. Tag 21C for this menu 20C and other tags 21A and 21B, as shown in FIG. 6A, are also displayed.

Semi-transparent cursor 22 for selecting displayed items is displayed fixedly at approximately the center of the screen. A functional item, i.e. channel “3,” selected by this cursor 22 is displayed larger than the other channel selecting items such as “1” and “2.”

A “←” shown at the left side of this “3” indicates that a combination of multiple items is displayed as a new functional item. This “←” and “3” which is currently selected by cursor 22 are displayed larger than the other functional items. This makes it easy to identify which has been selected, facilitating the selecting operation.

Transparent touch panel 16 is disposed on an area of this “3” as entry key 16A.

For selecting the first number “2” in the channel “213” of STB, up/down key 12D is rotated downward because this “2” is located above cursor 22 at the center. Same as in the first exemplary embodiment, each functional item displayed in menu 20C moves downward by this operation.

In other words, as shown in FIG. 6B, “3” displayed moves downward out of cursor 22, and “2” moves to cursor 22. Accordingly, “2←2” is displayed larger than the other functional items instead of “3←3.”

If a predetermined time passes, for example 1 sec or more, while “2←2” is displayed, controller 13 stores “2” to the left of “←.”

Selection key 12D is kept rotated downward to move “1” to the position of cursor 22. Since controller 13 has already stored “2,” newly selected “1” lines to the left of “←” next to stored “2,” and two digits “21←1” is displayed.

Then, after a predetermined time passes while “21←1” is displayed, in the same way, controller 13 stores “21” to the left of “←” as a new functional item.

In the same way, selection key 12D is further rotated to move “3” to the position of cursor 22 so that “213←3” is displayed as shown in FIG. 6D. After a predetermined time passes in this state, controller 13 stores 3 digits “213” to the left of “←” as a new functional item.

When entry key 16A disposed on the front face of “213” is pressed in this state, controller 13 detects this action, and outputs an electrical signal for remote control corresponding to “213.” Transmitter 4 transmits this electrical signal in the form of an infrared optical signal to STB so as to set the channel of STB to “213.”

As described above, entry key 12A is a transparent touch panel 16 in the second exemplary embodiment, and this touch panel 16 is disposed on the front face of display 11. Since the operation is executed on display 11 where the functional item is displayed, easy operation linked to the screen is achieved.

In addition, operation of up/down selection key 12D enables the selection of multiple functional items such as “2,” “1,” and “3,” and controller 13 stores the combination “213” as a new functional item, allowing to easily add new functional items composed of several digits by combining different numbers. Accordingly, operation of channels with 3 or more digits such as in STB can be facilitated.

Moreover, controller 13 stores a functional item such as “2,” “1,” or “3” after a predetermined time in continued operation of up/down selection key 12D, for example after 1 second. This enables the addition of a new numerical item such as “213” without complicated operations.

Still more, controller 13 detects the state that input unit 15 and transparent touch panel 16 are not operated for a predetermined time, and turns off the display. For example, if nothing is operated for about 20 to 30 minutes, the display is automatically turned off to reduce power consumption.

In the above description, the mobile terminal is used for communications from the mobile terminal to an apparatus such as STB one-way. However, the present invention is also applicable to bi-directional communications in which communications from the apparatus to mobile terminal are also featured.

For example, a receiver such as a photodiode for receiving an infrared optical signal and converting it to an electrical signal can be added to the structure of the mobile terminal described in the second exemplary embodiment, and a transmitter for transmitting an infrared optical signal is added to the apparatus for establishing bi-directional communications between the mobile terminal and apparatus. This enables the sending and receiving of information on programs, for example, between the apparatus and mobile terminal, and display of the information on display 11.

In addition, the present invention sends the infrared optical signal from transmitter 4 for remote controlling an apparatus such as STB. However, the present invention can also use radio waves for remote controlling apparatuses.

In the present invention, cursor 22 is fixed at approximately the center of the screen. However, as in the prior art, the cursor can be designed to move vertically and horizontally by operating a key vertically and horizontally for selecting a required functional item in the menu. The cursor can also be used for selecting a required tag from multiple tags.

Still more, the mobile terminal is used as a remote control for remote controlling several apparatuses. However, the mobile terminal can also be used as an exclusive remote control for remote controlling only the STB apparatus, for example, and displaying names of functional items peculiar to the STB apparatus to be operated in the tag section.

Furthermore, the mobile terminal uses a transparent touch panel for the entry key, and this touch panel is disposed on the front face of the display. However, the selection key can also be configured with the transparent touch panel.

Accordingly, the present invention offers an easy-to-use mobile terminal with fewer operations.

What is claimed is:

1. A mobile terminal comprising:
a display having a menu section for displaying a predetermined function and a tag section for displaying a name of said menu section;
an input unit where a selection key and an entry key are disposed; and
a controller connected to said input unit and said display,
wherein a plurality of tags are displayed on said tag section, and said controller displays contents of one of said tags, after being selected using said selection key, on said menu section.

2. The mobile terminal as defined in claim 1, wherein said selection key has an approximately cylindrical shape, said selection key being rotated in one of vertical and horizontal directions for selecting an item in one of said menu section and said tag section.

3. The mobile terminal as defined in claim 2, wherein a plurality of functions displayed in said menu section are disposed in an approximately circular arc.

4. The mobile terminal as defined in claim 1, wherein the predetermined function selected in said menu section is displayed larger than other functions.

5. The mobile terminal as defined in claim 1, wherein at least one of said selection key and said entry key is made of a transparent touch panel disposed on a front face of said display.

6. The mobile terminal as defined in claim 1, wherein a plurality of functions are selected by operating said selection key, and a combination of said selected functions is stored in said controller as a new function.

7. The mobile terminal as defined in claim 6, wherein the function selected by continuously operating said selection key for a predetermined time is stored in said controller as a new function.

8. The mobile terminal as defined in claim 1, wherein said controller detects a state that said input unit is not operated for a predetermined time, and turns off said display.

9. The mobile terminal as defined in claim 1 further comprising a transmitter for receiving an electrical signal from said controller and outputting said electrical signal in the form of an infrared optical signal.

10. The mobile terminal as defined in claim 1 further comprising a receiver for receiving an infrared optical signal and converting said infrared optical signal to an electrical signal.
